(19) United States
(12) Patent Application Publication
(10) Pub. No.: US 2014/0131334 A1
(43) Pub. Date: May 15, 2014

(54) Gas tungsten arc welding using arcing-wire

(71) Applicants: YuMing Zhang, Nicholasville, KY (US); Jinsong Chen, Lexington, KY (US); Yi Lu, Lexington, KY (US)

(72) Inventors: YuMing Zhang, Nicholasville, KY (US); Jinsong Chen, Lexington, KY (US); Yi Lu, Lexington, KY (US)

(73) Assignee: Adaptive Intelligent Systems LLC

(21) Appl. No.: 13/694,230

(22) Filed: Nov. 13, 2012

(51) Int. Cl. B23K 9/00

(52) U.S. Cl. CPC B23K 9/0008
USPC 219/137 R; 219/136

(57) ABSTRACT

In gas tungsten arc welding (GTAW), the achievable deposition rate of the filler wire is coupled with the arc energy and the mass of the molten metal in the weld pool. In this invention, a side arc is added into the GTA (gas tungsten arc) between the wire and the same tungsten that establishes the GTA with the work-piece. While its anode provides a GMAW (gas metal arc welding) melting mechanism to completely melt the wire at high speeds, the undesirable dependence of deposition rate on the weld pool mass is also eliminated. As a result, the deposition rate is increased and the ability to provide desirable deposition rate and base metal melting/penetration freely without coupling is established for the GTAW.

### GOVERNMENT INTEREST STATEMENT

The present invention was made with government support under contract N00024-09-C-4140 awarded by the Department of the Navy. The government has certain rights in the invention.

Government support also includes the matching fund from the Kentucky Cabinet for Economic Development (CED) Office of Commercialization and Innovation (KSTC-184-512-09-067).

### FIELD OF THE INVENTION

This invention relates to arc welding, and more particularly to gas tungsten arc welding and its variants.

### BACKGROUND OF THE INVENTION

Gas tungsten arc welding (GTAW) is a widely used welding process for metal joining [1-3]. Its arc is established between the tip of the non-consumable tungsten electrode and the work-piece [4] with a shielding gas [5, 6] applied to protect the arc and the weld pool area. GTAW can be used in the welding of a wide variety of metals. It is typically used for root passes on pipes and thin gauge materials. Its arc is very stable and can produce high-quality and spatter-free welds without requiring much post-weld cleaning. A typical GTAW system consists of a power supply, a water cooler, a welding torch, cables, etc. For most its applications, direct current electrode negative (DCEN) polarity is used and approximately 70% of the arc heat is applied into the work piece. Opposite to the direct current electrode positive (DCEP) polarity, the DCEN polarity produces a relatively narrow and deep weld [3, 7].

In order to achieve desirable welds, filler metals are typically required during GTAW. Currently, there are two most commonly used approaches for filling the wire: cold wire GTAW process and hot wire GTAW process. In the cold wire GTAW process [8], the filler wire is directly added as is. To melt the wire faster, in the hot wire GTAW [9], the filler wire is pre-heated by a resistive heat while it is being fed into the weld pool. This resistive heat is generated by a separate current (typically an alternating-current (AC)) [10, 11] supplied to the filler wire that flows from the wire directly into the weld pool. The current is properly adjusted so that ideally the temperature of the filler wire can reach its melting point as soon as it enters the weld pool. In comparison with the cold wire GTAW, the hot wire GTAW process is more complicated and has a higher cost with the additional power supply, but it can provide a higher deposition rate.

Despite the increased temperature of the filler wire when it enters into the weld pool, the wire melting is still finished by the heat generated from the weld pool during the hot wire GTAW process. That is, part of the heat used to melt the filler wire is essentially absorbed from the weld pool. To melt the wire faster, the arc would have to establish a larger weld pool. Increasing the melting or deposition rate is thus at the expense of an increased weld pool. The arc energy and deposition rate are thus coupled. This coupling reduces the process controllability to provide desirable arc energy and deposition rate freely to meet the requirements from different applications. In addition, for overhead welding where the maximal mass of the weld pool is restricted this coupling also directly reduces the amount of the filler metal that can be added each pass. The productivity is thus directly reduced because of this coupling or undesirable process controllability.

### SUMMARY OF THE INVENTION

In the conventional hot-wire GTAW shown in FIG. 1, an arc 12 is established between the tungsten 10 and the work-piece that includes the solid work-piece 15, liquid weld pool 14 and solidified weld 16. An added wire 11 is heated by the resistive heat due to the wire current I_{w} 18 and be finally melted by the heat from the molten metal of the liquid weld pool 14 after merging into the liquid weld pool 14. There is no air gap between the wire 11 and the liquid weld pool 14 (or the connecting solid work-piece 15 or the connecting solidified weld 16) to form an arc between them. The wire 11 is not a terminal of an arc and is not melted by an arc terminal where the energy and heat is highly concentrated. There is no current flow between the tungsten 10 and the wire 11.

In the embodiment of the present invention shown in FIG. 2, there are (1) an air gap between the wire 21 and the weld pool 24; (2) a current flow 28 between the wire 21 and tungsten 20; (3) an arc 23 between the tungsten 20 and the wire 21; (4) an arc terminal 231 on the wire to heat the wire 21 at high speeds. The arc 23 is considered an added second or side arc to the first or main arc 22 established between the tungsten 20 and the work-piece including the liquid weld pool 24.

### BRIEF DESCRIPTION OF THE DRAWINGS

FIG. 1 (Prior Art) shows the principle of the conventional hot wire GTAW known to one of ordinary in the art.

FIG. 2 (This Invention) shows the principle of this invention.

FIG. 3 (Prior Art) is an embodiment of the conventional hot wire GTAW known to one of ordinary skill in the art.

FIG. 4 illustrates the dependence of the maximal deposition rate on the arc energy in the conventional hot wire GTAW.

FIG. 5 (Prior Art) shows the principle of a modified hot-wire GTAW that uses a second arc to increase the melting speed of the wire. However, the melting of the wire is still finished after merging into the weld pool and there is no arc between the wire and the tungsten.

FIG. 6 (This Invention) is an embodiment of the present invention.

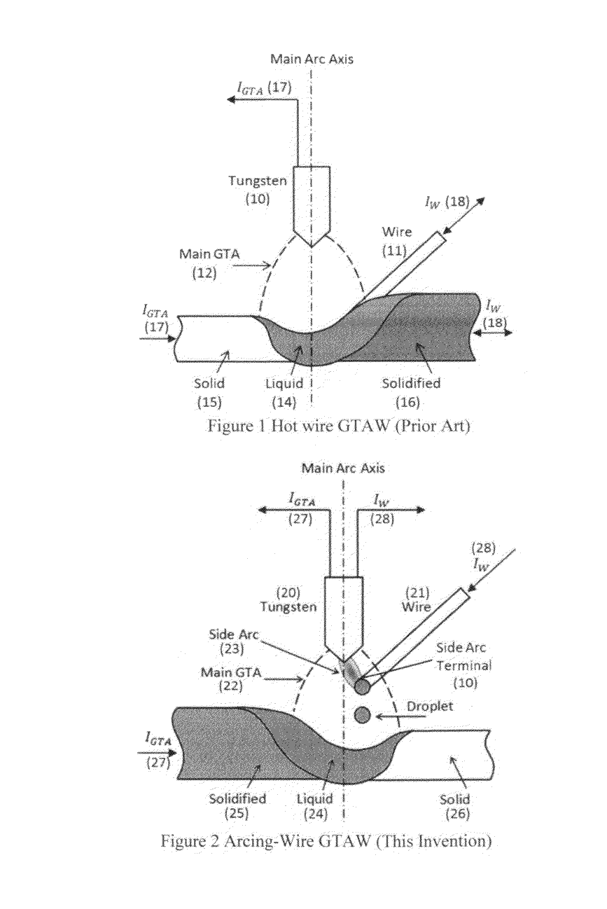

### DETAILED DESCRIPTION OF THE INVENTION

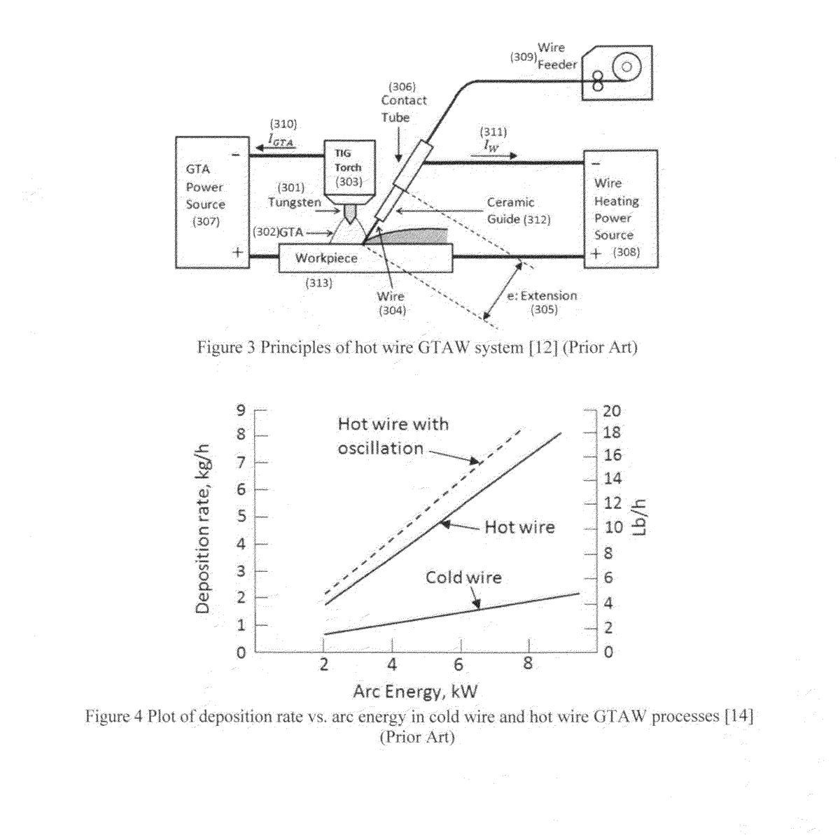

FIG. 3 illustrates the block diagram of a typical hot wire GTAW system. As shown in FIG. 3, a hot wire loop commonly includes a wire feeder 309, a wire heating power supply 308 (typically an alternating-current (AC)), a contact tube 306 and a ceramic isolation guide 312. After the gas tungsten arc (GTA) 302 is established, the wire 304 is fed into the weld pool on the work-piece 313. As a result, the hot wire current loop is closed and the current 311 flowing through the wire generates the resistance heat in the wire 304:

P=I₂²R_{w} (1)

R_{w}=ρl/(πr²) (2)

where:
P is the power of the resistance heat;
I_{w} is the current passing through the wire 304;
R_{w} is the resistance of the wire extension 305;
ρ is the electrical resistivity of the wire 304;
l is the length of the wire extension 305;
r is the radius of the wire 304.

It is clear that the wire diameter and the length of wire extension 305 decide the resistance and thus the resistance heat. By using this heat, ideally the filler wire 304 is able to heat up close to its melting point. As a result, the wire deposition rate can be increased. FIG. 4 shows the comparison of the deposition rate between the cold and hot wire GTAW processes[12]. It can be seen that the arc energy in the hot wire GTAW significantly increases the deposition rate. That is, the deposition rate is coupled with the arc energy.

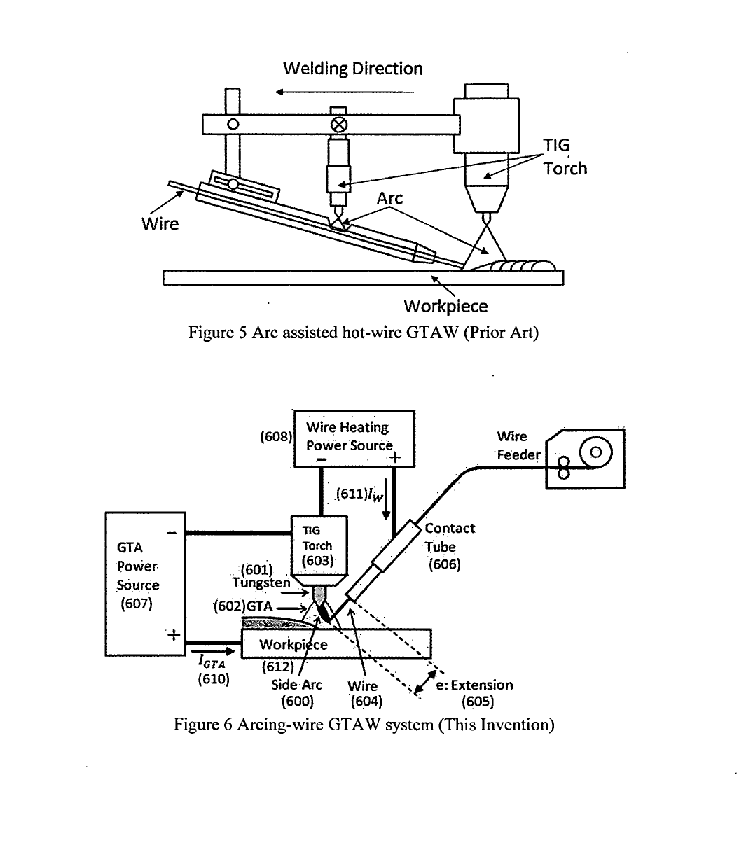

In addition to the coupling between the deposition rate and arc energy, there are other issues associated with the hot-wire GTAW. One of these issues is that its deposition rate is still limited especially when the electric resistivity of the wire material is relatively low. To resolve this issue, a second arc has been added to increase the pre-heat temperature of the wire using the system as shown in FIG. 5[13, 14]. This effort is a demonstration of the awareness of welding community about the dependence of the effectiveness of the hot-wire GTAW on the wire material. Another issue is that, in all cases for hot-wire GTAW process, the resistance heat generated within the cable becomes significant in comparison with the effective heat that preheats the wire. This part of resistance heat is not only wasted but also calls for an increased diameter/weight/cost/operation-inconvenience of the cable.

To overcome the issues associated with the hot-wire GTAW, the wire melting mechanism in GMAW is introduced into the GTAW in this invention resulting in the arcing-wire GTAW.

FIG. 6 is a realization and embodiment of the arcing-wire GTAW (this invention) shown in FIG. 2. Both the GTA power source 607 and the wire heating power source 608 can work in Constant Current (CC) mode such that the GTA current (I_{GTA}) 610 and the wire melting current (I_{W}) 611 can be controlled at desired levels. Different (I_{GTA}, I_{W}) combinations have been experimented. The components used in this embodiment are listed in Table 1 although other similar components can also be used and selected by one with ordinary skill in the art.

TABLE 1
Arcing-Wire Experimental System Components

| Equipment and Accessories | Model, material or Size |
|---|---|
| GTA power supply 607 | Thermal Arc Power-Master 500 |
| Wire heating power supply 608 | Miller PM 200 |
| Wire feeder 609 | Miller S-74D |
| GTAW torch 603 | Weldcraft WP-18P 500 amp TIG gun |
| Filler wire torch 606 | Bernard MIG gun - 400 amp Q-Gun |
| Diameter of filler wire 604 | 0.045 inch |
| Shielding gas of GTAW torch 603 | Pure Argon |
| Shielding gas of filler wire torch | None |
| 606 | |

In the embodiment shown in FIG. 6, the wire 604 is continuously fed by the wire feeder 609. The melted wire is transferred into the work-piece 612. To maintain the side arc 600, the melting speed must be balanced with the feeding speed. The wire current 611 needs to be appropriate to control the melting speed to balance with the feeding speed that is set to be constant in most applications such that the length of the side arc is in a moderate range. A too long side arc length may extinguish the side arc and a too short side arc length may indicate that the wire is approaching the work-piece. The side arc will not be maintained in both cases.

A method to provide an appropriate wire current 611 is to use a constant-current power supply as the wire heating power source 608 and set the current output at the appropriate level. The appropriate level of the wire current to be set for the constant-current power supply can be determined experimentally for the given feeding speed with the given wire material, wire diameter, and shield gas. Because the voltage of an arc is proportional to the length of the arc, maintaining the side arc length at an appropriate level to sustain the side arc can be achieved by controlling the voltage of the side arc at an appropriate level. To this end, the appropriate level of the wire current may also be determined by measuring the voltage between the wire 604 and the tungsten 601 and use this measured voltage to increase/reduce the desired amperage for the wire current 611 if this measured voltage is lower/higher than the desired voltage. The desired voltage should be slightly higher than the arc voltage in typical GTAW applications because of the use of a tungsten similar as in GTAW and the smaller size of the wire in comparison with a work-piece in typical GTAW. The desired increase/decrease in the amperage is used to change the setting of the constant current power supply.

Another method to provide an appropriate wire current 611 is to use a constant-voltage power supply as the wire heating power source 608. Again, the desired voltage should be slightly higher than the arc voltage in typical GTAW applications because of the use of a tungsten similar as in GTAW and the smaller size of the wire in comparison with a work-piece in typical GTAW. This desired voltage is set for the constant-voltage power source that will automatically adjusts the current to the appropriate level to maintain the voltage between the wire and the tungsten at the desired level.

### SUMMARY AND ANALYSIS OF ADVANTAGES

Melting Speed: The hot-wire GTAW uses the resistive heat to pre-heat the wire at power P_{w}=I_{w}^{R}R_{w}=I_{w}V_{w} where I_{w}, V_{w} and R_{w} are the wire current, voltage and resistance. In the arcing-wire GTAW, this resistive heat still heats the wire but an addition power, I_{w}V_{anode} where V_{anode} is the anode voltage drop, is added. The heat the arcing wire GTAW provides to heat/melt the wire is thus

$$k = \frac{{I}_{w} {V}_{w} + {I}_{w} {V}_{anode}}{{I}_{w} {V}_{w}} = 1 + {V}_{anode} / {V}_{w} \qquad ( 1 )$$

times of that provided by the hot-wire GTAW. Because R_{w} is small for the metal wire as an excellent conductor, V_{w}=I_{w}R_{w} is typically much smaller than V_{anode} unless an extremely high current I_{w} is used. The wire in the arcing wire GTAW is melted at the same speed as in the GMAW for the same (wire) current. It is true that the hot-wire GTAW also uses part of the heat from the weld pool to finish the melting of the wire. However, the deposition rate achievable by hot-wire GTAW is much lower than that achievable by GMAW. Because the deposition rate achievable by arcing-wire is the same as that by GMAW, the deposition/melting rate for the arcing-wire is much improved.

Energy Efficiency: Denote the resistance of the cable as R_{c}. This is apparent that the energy efficiency for hot-wire GTAW is

$${η}_{1} = \frac{{R}_{w}}{{R}_{c} + {R}_{w}} \qquad ( 2 )$$

For the arcing-wire GTAW, this efficiency is

η₂=(I_{w}R_{w}+V_{anode})/(V_{anode}+V_{cathode}+V_{column}+I_{w}R_{c}+I_{w}R_{w}) (3)

where V_{anode}+V_{cathode}+V_{column}+I_{w}R_{c}+I_{w}R_{w} is the welding voltage measured at the power supply with V_{anode}, V_{cathode} and V_{column} are the anode, cathode, and arc column voltage.

The resistivity of the wire extension increases with the temperature. The median between the room temperature 20° C. and melting point of the wire metal is used as the average temperature to compute an average resistivity for the wire extension in order to calculate the wire resistance. With reasonable estimates V_{cathode}=1 V, V_{column}=2 V, and V_{anode}=10 V, the resistance for the wire extension and cable, the energy efficiency for the hot-wire GTAW and arcing-wire GTAW under I_{w}=200 A, and the energy efficient improvement ratio η₂/η₁ can be calculated as listed in Table 2 for different cases assuming that the diameter of the wire and copper cable is 1.2 mm and 10 mm respectively. The materials' properties used in calculation include: (1) melting point for carbon steel: 1500° C.; (2) melting point for copper: 1084° C.; (3) resistivity for carbon steel: 1.43×10⁻⁷ Ω/m (20° C.) ; (4) resistivity for copper: 1.68×10⁻⁸Ω/m (20° C.); (5) temperature coefficient of resistivity for carbon steel: 0.004/° C.; (6) temperature coefficient of resistivity for copper: 0.003/° C. As can be seen, the energy efficiency is in general significantly improved especially for short wire extension, long cable, and metal with excellent conductivity. In addition, while the energy efficiency for the hot-wire GTAW varies significantly, it is almost constant for the arcing-wire GTAW. Use of the arc as the major heat source is responsible for this excellent characteristic of arcing-wire GTAW.

TABLE 2
Comparison of Energy Efficiency

| Case | | | |
|---|---|---|---|
| #1 | #2 | #3 | #4 |

| | | | | |
|---|---|---|---|---|
| Wire Material | Carbon Steel | Copper | Carbon Steel | Copper |
| Extension (mm) | 20 | 20 | 15 | 15 |
| Wire Resistance (Ω) | 0.0081 | 0.00093 | 0.0061 | 0.00070 |
| Cable Length (m) | 10 | 10 | 20 | 20 |
| Cable Resistance | 0.00214 | 0.00214 | 0.00428 | 0.00428 |
| (Ω) | | | | |
| Wire Current (A) | 200 | 200 | 200 | 200 |
| Energy Efficiency: | 79% | 30% | 59% | 14% |
| Hot-wire | | | | |
| Energy Efficiency: | 77% | 75% | 74% | 73% |
| Arcing-wire | | | | |
| Improvement Ratio | 97.5% | 247% | 127% | 517% |

Arc Controllability: GTAW competes with GMAW by its excellent arc controllability. In GMAW, the wire is melted by the arc anode effectively to realize the high productivity. However, the arc root or cathode where the electron emission occurs is highly mobile on the work-piece [15], causing that the arc in GMAW is not as stable as it can be in GTAW where the electron emission occurs at the tungsten. Further, to achieve a spray transfer that is often the preferred mode for many applications, the current must be greater than the transition current [16, 17]. While the pulsed arc control [18] offers an ability to achieve the traditionally preferred spray transfer at a wide range of average current and the STT (surface tension transfer) [19] and CMT (cold metal transfer) [20] change the short-circuiting transfer from a traditionally unstable process with spatters to a stable process with spatters minimized, the current waveforms are not freely determined by the applications and the effectiveness of these methods dictates the current waveform. The arc controllability of the GMAW process is still not comparable with the GTAW that can deliver any amperage and current waveform in reasonable ranges with no practical constraints/coupling.

In the arcing-wire GTAW, the amperage and current waveform applied into the work-piece is independently controlled with no constraints as in conventional GTAW. Hence, the arcing-wire GTAW melts the wire with the same productivity as GMAW but maintaining the ability to freely deliver the current and current waveform per the requirements from the application. As can be seen in the experimental verification section, the fluctuations in the current and voltage in the arcing-wire GTAW is only slightly increased from that in autogenous GTAW without wire. The excellence of the arc controllability in GTAW is thus approximately retained by the arcing wire GTAW.

Weld Controllability: Welding processes deliver mass and heat input into the work-piece to produce welds. A requirement for an ideal arc welding process is the ability to provide desired mass and heat input in reasonable range without coupling. In this study, this ability is referred to as the weld controllability and is measured by the range of ρ, the ratio of the melting heat in the total heat input into the work-piece.

In GMAW, mass and heat input are coupled. A simplified equation to calculate the power for the total heat input into the work-piece is IV=I(V_{w}+V_{anode}+V_{column}+V_{cathode}) where I, V and V_{w} are the welding current, welding voltage, and wire extension voltage, respectively. IV_{column} is actually lost through radiation and IV_{w} is much smaller than I(V_{anode}+V_{cathode}). Hence, the power for the total heat input into the work-piece is approximately I(V_{anode}+V_{cathode}). On the other hand, the mass melting speed is determined by IV_{anode}. Hence,

ρ≈V_{anode}/(V_{anode}+V_{cathode}) (4)

and this fixed ratio is relatively large in comparison with the lowest achievable by GTAW.

While a great ρ generally benefits typical GMAW applications that require wire deposition, it adversely affects the ability of GMAW in applications that require a certain work-piece heat input to achieve the penetration but does not require substantial mass input. Root pass in welding a groove is such an application requiring a low ρ. While the GMAW lacks this weld controllability, the arcing-wire GTAW can deliver the same adjustable low ρ and have ρ=0 as conventional GTAW processes.

Ideal Weld Controllability: As aforementioned, the range and adjustability of ρ measure the weld controllability of an arc welding process. In addition to root pass where an adjustable low ρ is required, many applications require high ρ to deposit metal at high speeds with lowest heat inputs. Conventional GTAW and GMAW both lack the ability to provide a high ρ because GTAW relies on the heat from the weld pool to finish the melting of the wire and GMAW has a fixed ρ. However, the arcing-wire GTAW can theoretically provide ρ=1 with a zero base metal current. The arcing-wire GTAW thus theoretically has the ability to provide a full range ρ∈ [0,1] although effective use for extreme ρ is yet to be explored. Overlaying/cladding and cover pass welding can be considered applications where a high ρ benefits. Also, depositing on sheet metal may also benefit from a high ρ.

Example Analysis: The heat needed to melt 1 kg of various steels from the room temperature is less than 1000 KJ approximately. From FIG. 2, the hot-wire GTAW requires 10 kW arc power to achieve 9 kg/hour deposition rate. The heat used to melt the wire is 9000 KJ per hour. The total heat input into the work-piece is more than that provided by the arc which is 10*60*60=36000 KJ per hour because the wire power supply also provides heat. The melting heat ratio in the total heat input is thus lower than 9000/36000=25%. ρ in the hot-wire GTAW is thus not comparable with 71% that has been experimentally demonstrated for the proposed arcing-wire GTAW process. The controllability of the arcing-wire GTAW is thus greatly extended from the hot-wire GTAW. 71% is also of course much greater than that for GMAW (DC straight-polarity) which is approximately 33% because the voltage of the cathode on steel (work-piece) is approximately twice of that for the voltage of the anode (steel wire) [21].

### REFERENCES

1. Welding Handbook. 8 ed, ed. R. L. O'Brien. Vol. 2: Welding Processes. 1991: American Welding Society.
2. Moniz, B. J. and R. T. Miller, Welding Skills. 4 ed 2010: American Technical Publisher.
3. Key, J. F., Arc Physics of Gas-Tungsten Arc Welding. 10 ed. ASM Handbook. Vol. 6. 1993: ASM International.
4. Zhang, Y. M., R. Kovacevic, and L. Li, Adaptive Control of Full Penetration Gas Tungsten Arc Welding. IEEE Transactions on Control Systems Technology, 1996. 4(4): p. 10.
5. Zhang, Y. M., Real-Time Weld Process Monitoring 2008: CRC Press. 16.
6. Lyttle, K. A., Shielding Gases for Welding. 10 ed. ASM Handbook. Vol. 6. 1993: ASM International.
7. The Welding Handbook for Maritime Welders. 10 ed: Barwil Unitor Ships Service.
8. Meng, L., et al. Research and development of high energy pulse precision cold-welding technology. in 2011 International Conference on Advanced Engineering Materials and Technology, AEMT 2011, Jul. 29, 2011-Jul. 31, 2011. 2011. Sanya, China: Trans Tech Publications.
9. Shinozaki, K., et al., Melting phenomenon during ultra-high-speed GTA welding method using pulse-heated hot-Wire. Yosetsu Gakkai Ronbunshu/Quarterly Journal of the Japan Welding Society, 2009. 27: p. 22s-26s.
10. Alexander, C. K. and M. N. O. Sadiku, Fundamentals of Electric Circuits. 3 ed 2000: McGraw Hill.
11. Paul, C. R., Fundamentals of Electric Circuit Analysis. 1 ed 2000: John wiley & Sons.
12. Irving, R. R., Tig quality, mig speed combined in hot wire welding process. Iron Age, 1966. 198(15): p. 61-64.
13. Lv, S. X., et al., Investigation on TIG cladding of copper alloy on steel plate. Science and Technology of Welding and Joining, 2008. 13(1): p. 10-16.
14. Lv, S. X., et al., Arc heating hot wire assisted arc welding technique for low resistance welding wire. Science and Technology of Welding and Joining, 2007. 12(5): p. 431-435.
15. Zhang, Y. M., 2011. Arc Physics of Gas Tungsten and Gas Metal Arc Welding. In ASM Handbook, Volume 6A: Welding Fundamentals and Processes, Editor(s): Thomas Lienert, Thomas Siewert, Sudarsanam Babu, and Viola Acoff. ASM International.
16. Lowke, J. J. 2009. “Physical basis for the transition from globular to spray modes in gas metal arc welding”, Journal of Physics D: Applied Physics, 42(13): 1-7.
17. Wang, G., G. Huang, and Y. M. Zhang, 2004. “Numerical analysis of metal transfer in gas metal arc welding under modified pulsed current conditions,” Metallurgical and Materials Transactions B, 35(5): 991-999.
18. Amin, M., 1983. “Pulse current parameters for arc stability and controlled metal transfer in arc welding,” Metal Construction, 15: 272-278.
19. Stava, E. K., 2006. Short circuit arc welder and method of controlling same. U.S. Pat. No. 7,109,439.
20. CMT: Cold Metal Transfer, MIG/MAG dip-transfer arc process. Brighton: Fronius USA LLC, 2007.
21. Soderstrom, E. J., K. M. Scott, P. F. Mendez, 2011. “Calorimetric measurement of droplet temperature in GMAW,” Welding Journal, 90(4): 77s-84s.

What is claimed is:

1. A method to arc weld using a gas tungsten arc with a wire being melted by a terminal of a side arc comprising:
a gas tungsten arc as the main arc between the tungsten and work-piece;
a side arc between the tungsten and wire.

2. The method in claim 1, wherein the wire is continuously fed.

3. The method in claim 1, wherein the tungsten is held by a gas tungsten arc welding torch.

4. The method in claim 1, wherein the current of the main arc between the tungsten and work-piece is provided by a constant-current power supply.

5. The method in claim 1, wherein the wire current between the wire and tungsten is provided by a constant-current power supply or constant-voltage power supply.

6. A method to melt the work-piece and wire use arc terminals from two separate arcs using the method in claim 1, the method comprising:
establishing a main arc between the tungsten and work-piece to melt the work-piece using an arc terminal;
establishing and maintaining a side arc between the wire and electrode to melt the wire using another arc terminal.

7. A method to establish the two separate arcs in claim 6, the method comprising:
a tungsten serves as a common terminal for the two separate arcs;
another arc terminal in one of the two arcs is on the work-piece;
another arc terminal in another arc in the two arcs is at the tip of the wire.

8. A method to maintain the side arc in claim 7, the method comprising:
using a constant-current power supply to provide the wire current;
determining an appropriate amperage for the wire current to melt the wire at a speed that balance the wire feeding such that the wire tip does not dip into the weld pool and is in the umbra of the main arc;
determining the appropriate amperage for the wire current from experiments using the wire feed speed, wire diameter, and shielding gas;
automatically determining the appropriate amperage current using the voltage between the wire and tungsten as the feedback to controlling the voltage at a pre-specified level.

9. Another method to maintain the second arc in claim 7, the method comprising:
using a constant-voltage power supply to provide the wire current;
automatically determining the appropriate amperage current by setting the voltage for the constant-voltage power supply at a pre-specified level.

10. The arc that directly melts the work-piece using one of its terminals and the arc that directly melts the wire using one of its terminals shares a common terminal at the tungsten not on the work-piece.
